(19) United States
(12) Patent Application Publication
(10) Pub. No.: US 2023/0030369 A1
(43) Pub. Date: Feb. 2, 2023

(54) PROCESSING METHOD OF SOUND WATERMARK AND SOUND WATERMARK GENERATING APPARATUS

(71) Applicant: Acer Incorporated, New Taipei City (TW)

(72) Inventors: Po-Jen Tu, New Taipei City (TW); Jia-Ren Chang, New Taipei City (TW); Kai-Meng Tzeng, New Taipei City (TW)

(73) Assignee: Acer Incorporated, New Taipei City (TW)

(21) Appl. No.: 17/476,477

(22) Filed: Sep. 16, 2021

(30) Foreign Application Priority Data
Jul. 27, 2021 (TW) 110127497

(51) Int. Cl. G10L 19/018

(52) U.S. Cl. CPC G10L 19/018

(57) ABSTRACT

A processing method of sound watermark and a sound watermark generating apparatus are provided. In the method, a call reception sound signal is obtained by a sound receiver. A reflection sound signal is generated according to a virtual reflection condition and the call reception sound signal. The reflection sound signal is a sound signal obtained by simulating a sound output by the sound source, then being reflected by the external object, and being further recorded by the sound receiver. The phase of the reflection sound signal is shifted according to a watermark indication code to generate a sound watermark signal. The sound watermark signal includes the reflection sound signal with the phase shift. Accordingly, at the receiver end, the sound watermark signal via the feedback path could be eliminated by echo cancellation, and the sound watermark signal would not affect the speech signal on the call transmission path.

### CROSS-REFERENCE TO RELATED APPLICATION

This application claims the priority benefit of Taiwan application no. 110127497, filed on Jul. 27, 2021. The entirety of the above-mentioned patent application is hereby incorporated by reference herein and made a part of this specification.

### BACKGROUND

### Technical Field

The disclosure relates to a sound signal processing technique, and in particular, to a processing method of a sound watermark and a sound watermark generating apparatus.

### Description of Related Art

Remote conferencing allows people in different places or spaces to communicate, and the development of equipment, protocols, and applications regarding remote conferencing has considerably advanced. It is worth noting that a part of the instant conferencing applications may synthesize an audio signal and a sound watermark signal to identify a speaker.

For example, FIG. 1 is a schematic diagram describing a mobile device M adapted for a conference call with an example. Referring to FIG. 1, the mobile device M may receive a sound signal S1 via the Internet. The sound signal S1 includes a call reception signal obtained by making a recording on the speaker and a sound watermark signal. The sound watermark signal may be used to identify another device transmitting the sound signal S1. The call reception signal may be further played through a loudspeaker S so that a user sp of the mobile device M listens to the other user's voice. In addition, a sound receiver R (e.g. a microphone) makes a recording on the user sp to obtain a sound signal S2.

Generally, a major function of echo cancellation C on a call transmission path is eliminating a composition belonging to the call reception signal in the sound signal S2 obtained by the sound receiver R and further obtaining a sound signal S3 without an echo. However, a generating path of the sound watermark signal and the general path of the call reception signal may be different. When the sound receiver R receives a sound signal of the loudspeaker S through a feedback path fp, a composition belonging to the sound watermark signal in the sound signal S1 might not be eliminated and be further transmitted via the Internet. As a result, an audio composition of the user sp in the sound signal S3 on the call transmission path might be affected.

### SUMMARY

Accordingly, the embodiments of disclosure provide a processing method of a sound watermark and a sound watermark generating apparatus generating a sound watermark which may be eliminated by echo cancellation and thus enhance a quality of a call.

The processing method of the sound watermark of the embodiments of the disclosure is adapted for a conference terminal, and the conference terminal includes a sound receiver. The processing method of the sound watermark includes, but not limited to, the following steps. A call reception sound signal is obtained through the sound receiver. A reflection sound signal is generated according to a virtual reflection condition and the call reception sound signal. The virtual reflection condition includes a position relation among the sound receiver, a sound source, and an external object. The reflection sound signal is a sound signal which is obtained by simulating a sound output by a sound source, then being reflected by the external object, and being further recorded by the sound receiver. A phase of the reflection sound signal is shifted according to a watermark indication code to generate a sound watermark signal. The sound watermark signal includes the reflection sound signal with a phase shift.

The sound watermark generating apparatus of the embodiments of the disclosure includes, but not limited to, a memory and a processor. The memory is configured to store a program code. The processor is coupled to the memory. The processor is configured to load and execute the program code to obtain a call reception sound signal. The processor generates a reflection sound signal according to a virtual reflection condition and the call reception sound signal and shifts a phase of the reflection sound signal according to a watermark indication code to generate a sound watermark signal. The call reception sound signal is obtained by recording through a sound receiver. The virtual reflection condition includes a position relation among the sound receiver, a sound source, and an external object. The reflection sound signal is a sound signal which is obtained by simulating a sound output by the sound source, then being reflected by the external object, and being further recorded by the sound receiver. The sound watermark signal includes the reflection sound signal with a phase shift.

Based on the above, according to the processing method of a sound watermark and the sound watermark generating apparatus of the embodiments of the disclosure, the sound signal reflected by the external object is simulated. The simulated sound signal is encoded through phase shifting to generate the sound watermark signal. Accordingly, the general call reception signal and the sound watermark signal are maintained simultaneously at the loudspeaker end. In addition, the two signals may be eliminated by a conventional echo cancellation algorithm. Hence, an audio signal on a call transmission path is not affected.

In order to make the aforementioned features and advantages of the disclosure comprehensible, embodiments accompanied with drawings are described in detail below.

### BRIEF DESCRIPTION OF THE DRAWINGS

FIG. 1 is a schematic diagram describing a mobile device adapted for a conference call with an example.

FIG. 2 is a schematic diagram of a conference call system according to an embodiment of the disclosure.

FIG. 3 is a flow chart of a processing method of a sound watermark according to an embodiment of the disclosure.

FIG. 4 is a flow chart of a method for generating a sound watermark according to an embodiment of the disclosure.

FIG. 5 is a schematic diagram describing a virtual reflection condition according to an embodiment of the disclosure.

FIG. 6 is a schematic diagram describing a filtering processing according to an embodiment of the disclosure.

FIG. 7 is a schematic diagram describing multiple phase shifts according to an embodiment of the disclosure.

FIG. 8 is a schematic diagram describing two phase shifts according to an embodiment of the disclosure.

FIG. 9A is a simulation diagram describing a call reception sound signal with an example.

FIG. 9B is a simulation diagram describing an embedded watermark signal with an example.

FIG. 10 is a flow chart describing watermark identification according to an embodiment of the disclosure.

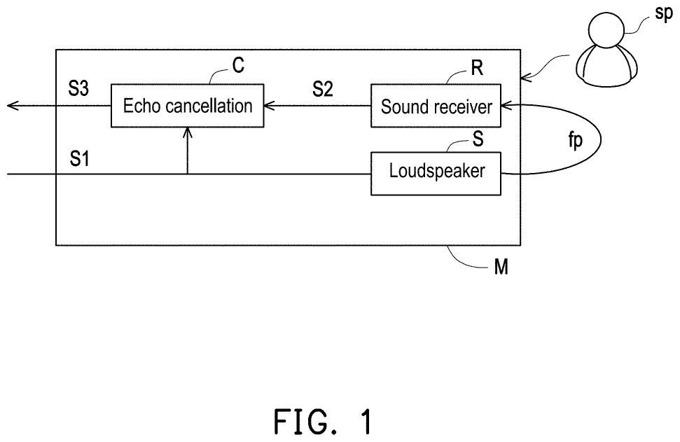

### DESCRIPTION OF THE EMBODIMENTS

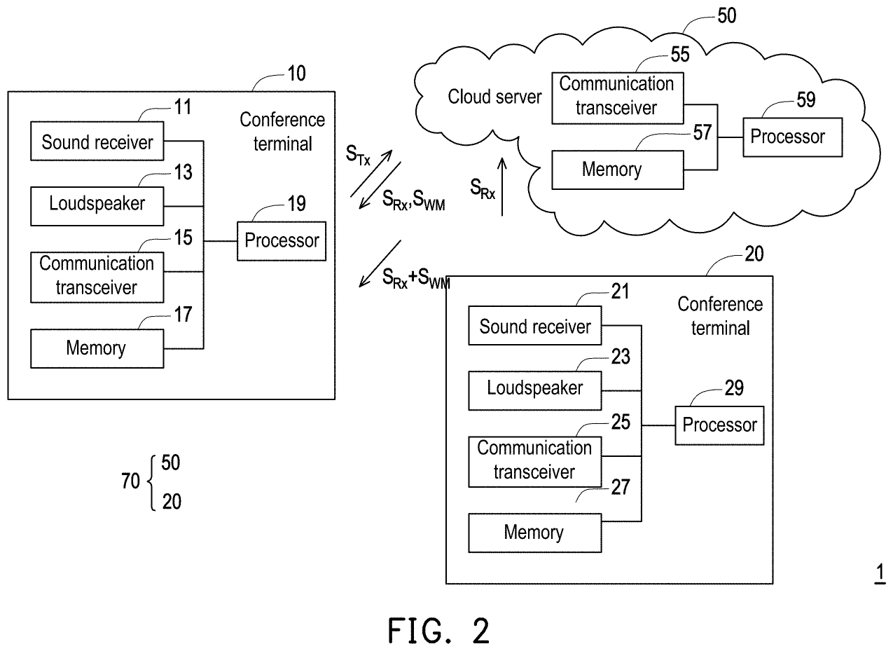

FIG. 2 is a schematic diagram of a conference call system 1 according to an embodiment of the disclosure. Referring to FIG. 2, the voice call system 1 includes, but not limited to, a conference terminal 10, a conference terminal 20, and a cloud server 50.

The conference terminal 10 and the conference terminal 20 may be a wired telephone, a mobile phone, an Internet phone, a tablet computer, a desktop computer, a laptop computer, or a smart speaker.

The conference terminal 10 includes, but not limited to, a sound receiver 11, a loudspeaker 13, a communication transceiver 15, a memory 17, and a processor 19.

The sound receiver 11 may be a dynamic microphone, a condenser microphone, or an electret condenser microphone. The sound receiver 11 may also be other combinations of an electronic device, an analog-to-digital converter, a filter, and an audio signal processor which may receive a sound wave (e.g. a human voice, an ambient sound, a sound of machine operation, or the like) to convert the sound wave into a sound signal. In an embodiment, the sound receiver 11 is configured to receive/record a sound from a speaker to obtain a call reception sound signal. In some embodiments, the call reception sound signal may include a voice of the speaker, a sound generated by the loudspeaker 13 and/or other ambient sounds.

The loudspeaker 13 may be a speaker or a megaphone. In an embodiment, the loudspeaker 13 is configured to play a sound.

The communication transceiver 15 is, for example, a transceiver (it may include, but not limited to, an element such as a connection interface, a signal converter, or a communication protocol processing chip) supporting a wired Internet such as Ethernet, fiber optic Internet, or cable Internet. The communication transceiver 15 may also be a transceiver (it may include, but not limited to, an element such as an antenna, an digital-to-analog/analog-to-digital converter, or a communication protocol processing chip) supporting Wi-Fi, the 4G networks, the 5G networks, or the later generation mobile networks. In an embodiment, the communication transceiver 15 is configured to transmit or receive data.

The memory 17 may be any type of fixed or mobile random access memory (RAM), read only memory (ROM), flash memory, conventional hard disk drive (HDD), solid-state drive (SDD), or other similar devices. In an embodiment, the memory 17 is configured to store a program code, a software module, a configuration setting, data (e.g. a sound signal, a watermark indication code, or a sound watermark signal), or a file.

The processor 19 is coupled to the sound receiver 11, the loudspeaker 13, the communication transceiver 15, and the memory 17. The processor 19 may be a central processing unit (CPU), a graphic processing unit (GPU), or other programmable general-purpose or special-purpose microprocessors, digital signal processor (DSP), programmable controller, field programmable gate array (FPGA), application-specific integrated circuit (ASIC), or similar device, or any combination of the above devices. In an embodiment, the processor 19 is configured to execute all of or a part of the tasks of the conference terminal 10 which the processor 19 belongs to. The processor 19 may load and execute each of the software modules, files, and data stored by the memory 17.

The conference terminal 20 includes, but not limited to, a sound receiver 21, a loudspeaker 23, a communication transceiver 25, a memory 27, and a processor 29. With regard to the executions and the features of the sound receiver 21, the loudspeaker 23, the communication transceiver 25, the memory 27, and the processor 29, the description regarding the sound receiver 11, the loudspeaker 13, the communication transceiver 15, the memory 17, and the processor 19 may be referred to. They are not repeated here. The processor 29 is configured to execute all of or a part of the tasks of the conference terminal 20 which the processor 29 belongs to. The processor 29 may load and execute each of the software modules, files, and data stored by the memory 27.

The cloud server 50 is connected to the conference terminal 10 and the conference terminal 20 directly or indirectly through the Internet. The cloud server 50 may be a computer system, a server, or a signal processing device. In an embodiment, the conference terminal 10 and the conference terminal 20 may also serve as the cloud server 50. In another embodiment, the cloud server 50 may serve as an independent cloud server which is different from the conference terminal 10 and the conference terminal 20. In some embodiments, the cloud server 50 includes, but not limited to, the same or a similar communication transceiver 55, a memory 57, and a processor 59, and the executions and the features of the elements will not be repeated.

In an embodiment, a sound watermark generating apparatus 70 may be the conference terminal 10, the conference terminal 20, or the cloud server 50. The sound watermark generating apparatus 70 is configured to generate a sound watermark signal, which will be described further in the embodiments below.

In the description below, accompanied by each of the devices, elements, and modules in the conference call system 1, the method of the embodiments of the disclosure will be described. Each step of the method may be adjusted according to the executions, and the disclosure is not limited thereto.

Note that, for convenience of description, the same element may realize the same or similar operation and will not be repeated. For example, all of the processor 19 of the conference terminal 10, the processor 29 of the conference terminal 20 and/or the processor 59 of the cloud server 50 may realize the same or similar method of the embodiments of the disclosure.

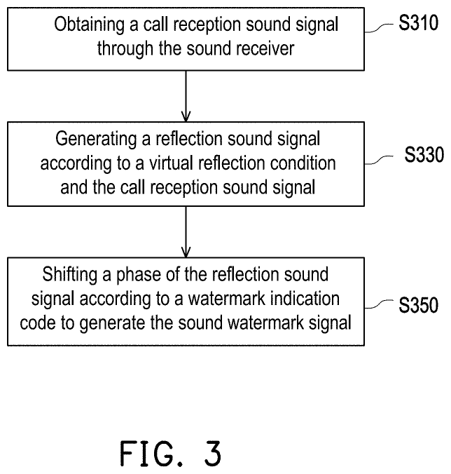

FIG. 3 is a flow chart of a processing method of a sound watermark according to an embodiment of the disclosure. Referring to FIG. 3, the processor 29 obtains a call reception sound signal S_{Rx} by recording through the sound receiver 21 (step S310). Specifically, it is assumed that the conference terminal 10 and the conference terminal 20 start a conference call. For example, a conference is started through a video call software, a voice call software, or a phone call, a speaker may speak instantly. After the sound receiver 21 records/receives a sound, the processor 29 may obtain the call reception sound signal S_{Rx}. The call reception sound signal S_{Rx} is related to an audio content of the speaker corresponding to the conference terminal 20 (may further include an ambient sound or other noise). The processor 29 of the conference terminal 20 may transmit the call reception sound signal S_{Rx} through the communication transceiver 25 (i.e. through an Internet interface). In some embodiments, the call reception sound signal S_{Rx} may be processed through echo cancellation, noise filtering and/or other sound signal processing.

The processor 59 of the cloud server 50 receives the call reception sound signal S_{Rx} from the conference terminal 20 through the communication transceiver 55. The processor 59 generates a reflection sound signal S′_{Rx} according to a virtual reflection condition and the call reception sound signal (step S330). Specifically, a common echo cancellation algorithm may adaptively eliminate compositions (e.g. the call reception sound signal S_{Rx} of the call reception path) belonging to reference signals in sound signals received by the sound receiver 11 and the sound receiver 21 from an outside. Sounds recorded by the sound receiver 11 and the sound receiver 21 include the shortest paths from the loudspeaker 13 and the loudspeaker 23 to the sound receiver 11 and the sound receiver 21 and different reflection paths of the environment (i.e. a path formed when a sound is reflected by an external object). A reflection sound signal may be affected by a reflection coefficient of a reflection object, and a reflection position affects a time delay and an amplitude attenuation of the sound signal. In addition, the reflection sound signal may also come from different directions, which leads to a phase shift. In the embodiments of the disclosure, a virtual/simulated reflection sound signal which may be eliminated by the echo cancellation is generated by using the sound signal S_{Rx} of a known call reception path. Therefore, a sound watermark signal S_{WM} is generated.

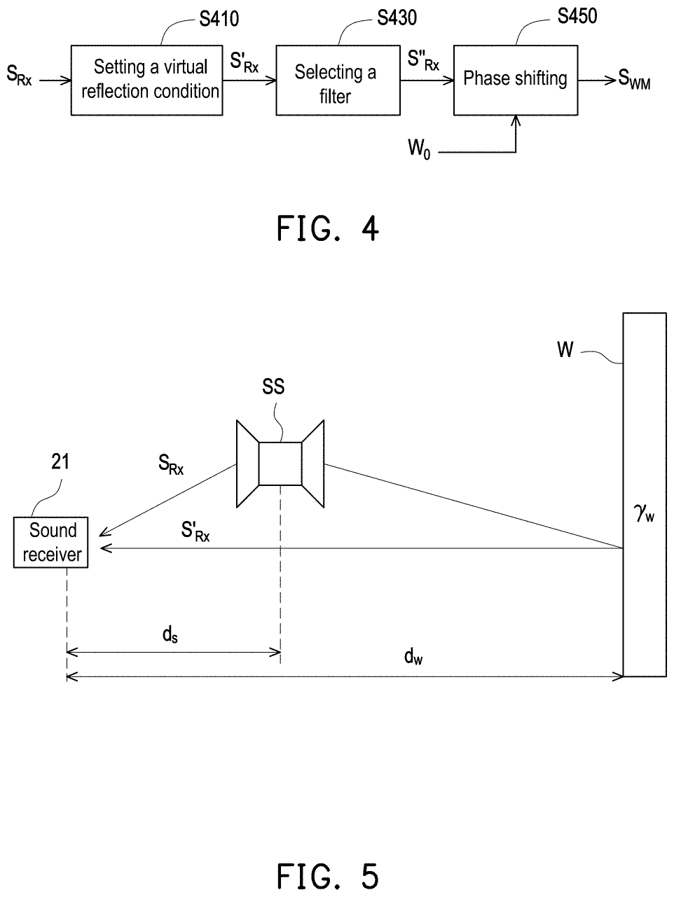

FIG. 4 is a flow chart of a method for generating the sound watermark signal S_{WM} according to an embodiment of the disclosure. Referring to FIG. 4, the processor 59 may set the virtual reflection condition to generate the reflection sound signal S′_{Rx} (step S410). Specifically, the virtual reflection condition includes a position relation among the sound receiver 11 and the sound receiver 21, a sound source (e.g. the speaker, the loudspeaker 13, or the loudspeaker 23), and an external object (e.g. a wall, a ceiling, a piece of furniture, or a person), such as a distance between the sound receiver 11 and the external object, the distance between the sound receiver 11 and the sound source, and/or a distance between the sound source and the external object. The reflection sound signal S′_{Rx} is a sound signal which is obtained by simulating a sound output by the sound source, then being reflected by the external object, and being further recorded by the sound receiver 11 and the sound receiver 21.

In an embodiment, the processor 59 may determine a time delay and an amplitude attenuation of the reflection sound signal S′_{Rx} compared with the call reception sound signal S_{Rx} according to the position relation and a reflection coefficient of the external object. For example, FIG. 5 is a schematic diagram describing a virtual reflection condition according to an embodiment of the disclosure. Referring to FIG. 5, it is assumed that the virtual reflection condition is a single wall (i.e. the external object), and a reflection coefficient of the wall W is γ_{w} (e.g. 0.7, 0.3, or 1). Under the conditions that a distance between the sound receiver 21 and the sound source SS is dₛ (e.g. 0.3, 0.5, or 0.8 m), and a distance between the sound receiver 21 and the wall W is d_{w} (e.g. 1, 1.5, or 2 m), a relation between the reflection sound signal S′_{Rx} and the call reception sound signal S_{Rx} may be represented as the following:

$${S}_{Rx}^{′} ( n ) = {γ}_{w} \cdot \frac{1 + {d}_{S}}{1 + 2 {d}_{w} - {d}_{S}} \cdot {S}_{R x} ( n - \frac{2 {d}_{w} - 2 {d}_{S}}{{v}_{S} \cdot {T}_{s}} ) \qquad ( 1 )$$

Tₛ is a sampling time, vₛ is a speed of a sound, and n is a sampling point or time.

If it is set that the reflection sound signal S′_{Rx} has a time delay γ_{w} and an amplitude attenuation α_{w} compared with the call reception sound signal S_{Rx}, a relation between the reflection sound signal S′_{Rx} and the call reception sound signal S_{Rx} may be represented as the following:

s′_{Rx}(n)=α_{w}·s_{Rx}(n−n_{w}) (2)

According to equation (1) and (2), the following equations are obtained:

$${α}_{w} = {γ}_{w} \cdot \frac{1 + {d}_{S}}{1 + 2 {d}_{w} - {d}_{S}} \qquad ( 3 )$$

$${n}_{w} = \frac{2 {d}_{w} - 2 {d}_{S}}{{v}_{S} \cdot {T}_{S}} - {n}_{f} - {n}_{φ} \qquad ( 4 )$$

n_{f} is a time delay (optionally, it will be further described in the embodiments below) caused by a filter, and n_{φ} is a time delay (optionally, it will be further described in the embodiments below) caused by a phase shift.

Note that according to different demand of design, a variable in the virtual reflection condition may be further adjusted. For example, there is more than one external object or relative position.

Referring to FIG. 3, the processor 59 shifts a phase of the reflection sound signal S′_{Rx} according to a watermark indication code Wₒ to generate the sound watermark signal S_{WM} (step S350). Specifically, when the conventional echo cancellation functions, compared with the phase shift of the reflection sound signal, the time delay and the change in the amplitude of the reflection sound signal cause a greater effect on errors of the echo cancellation. With the change, it is like being in a new disturbing environment to which the echo cancellation has to be adapted. Therefore, there is only the difference among the phases of the sound watermark signals S_{WM} corresponding to different values in the watermark indication code Wₒ of the embodiments of the disclosure, but the time delays and the amplitudes thereof are the same. That is, the sound watermark signal S_{WM} includes the one or multiple reflection sound signals S′_{Rx} with the phase shifts.

Referring to FIG. 4, in an embodiment, the processor 59 may select a filter to generate a reflection sound signal S″_{Rx} after a filtering processing (step S430). Specifically, a rate of convergence is relatively low when the conventional echo cancellation processes a low-frequency (e.g. 3 kHz or 4 kHz or below) sound signal, but a rate of convergence is relatively high (e.g. 10 ms or below) when processing a high-frequency (e.g. 3 kHz or 4 kHz or above) sound signal. Therefore, the processor 59 may only perform phase shifting on a high-frequency (4 kHz or 5 kHz or above) reflection sound signal S′_{Rx}, and a signal disturbance is thus not likely to be perceived by a human (i.e. the high-frequency sound signal is beyond the range of human hearing).

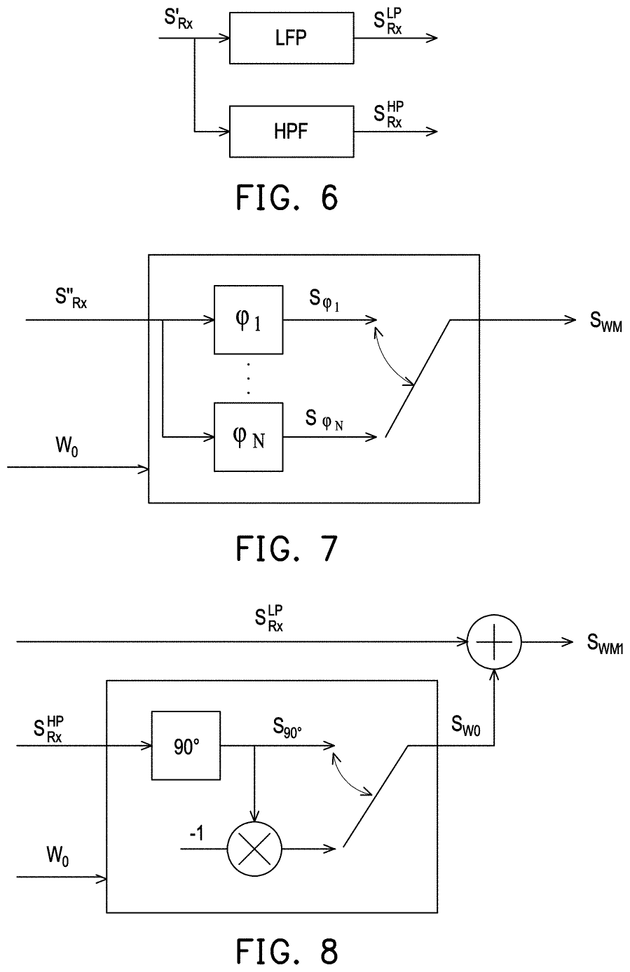

For example, FIG. 6 is a schematic diagram describing a filtering processing according to an embodiment of the disclosure. Referring to FIG. 6, the processor 59 may perform a low-pass filtering processing on the reflection sound signal S′_{Rx} through a low-pass filter LPF to output a reflection sound signal s_{Rx}^{LP} undergoing the low-pass filtering processing. For example, the low-pass filter LPF blocks a signal with a frequency of 4 kHz or above to pass and only allows a signal with a frequency of 4 kHz or below to pass. In addition, the processor 59 may perform a high-pass filtering processing on the reflection sound signal S′_{Rx} through a high-pass filter HPF to output a reflection sound signal s_{Rx}^{HP} undergoing the high-pass filtering processing. For example, the high-pass filter HPF blocks a signal with a frequency of 4 kHz or below to pass and only allows a signal with a frequency of 4 kHz or above to pass.

In another embodiment, the processor 59 may not perform a filtering processing of a specific frequency on the reflection sound signal S′_{Rx}. That is, the reflection sound signal S″_{Rx} is the same as the reflection sound signal S′_{Rx}.

Referring to FIG. 4, the processor 59 may perform phase shifting on the reflection sound signal S″_{Rx} according to the watermark indication code Wₒ (step S450). In an embodiment, the watermark indication code Wₒ is encoded with a multiple positional numeral system, and multiple values are provided for each of one or multiple digits of the watermark indication code Wₒ in the multiple positional numeral system. Taking the binary numeral system as an example, a value of each of the digits in the watermark indication code Wₒ may be “0” or “1”. Taking the hexadecimal numeral system as an example, a value of each of the digits in the watermark indication code Wₒ may be “0”, “1”, “2” . . . , “E”, or “F”. In another embodiment, the watermark indication code is encoded with letters, characters and/or symbols. For example, a value of each of the digits in the watermark indication code Wₒ may be any of the English letters “A” to “Z”.

In an embodiment, the different values of all the digits in the watermark indication code Wₒ correspond to different phase shifts. For example, FIG. 7 is a schematic diagram describing multiple phase shifts according to an embodiment of the disclosure. Referring to FIG. 7, it is assumed that the watermark indication code Wₒ adopts a base-N(N is a positive integer) numeral system, and N values are provided for each of the digits. The different N values respectively correspond to different phase shifts φ₁ to φ_{N}.

FIG. 8 is a schematic diagram describing two phase shifts according to an embodiment of the disclosure. Referring to FIG. 7, it is assumed that the watermark indication code Wₒ adopts the binary numeral system, and 2 values may be provided for each of the digits (i.e. 1 and 0). The different 2 values respectively correspond to two phase shifts φ and −φ. For example, the phase shift φ is 90°, and the phase shift −φ is −90° (i.e. −1).

The processor 59 may shift a phase of the reflection sound signal S″_{Rx} according to the values of the one or multiple digits in the watermark indication code Wₒ. For example, in FIG. 7, the processor 59 may select one or more among the phase shifts φ₁ to φ_{N} according to the one or multiple values in the watermark indication code Wₒ, and the selected phase shifts φ₁ to φ_{N} are used to perform phase shifting. For example, a value of the first digit of the watermark indication code Wₒ is 1, and an output reflection sound signal S_{φ1} with a phase shift is shifted φ₁ relative to the reflection sound signal S″_{Rx}. The rest of reflection sound signals S_{φN} may be derived similarly. Phase shifting may be achieved by adopting Hilbert transform or other phase shifting algorithms.

In an embodiment, the watermark indication code includes multiple digits. The sound watermark signal S_{WM} includes the multiple reflection sound signals with the phase shifts, and each of the reflection sound signals with the phase shifts occupies a time length in the sound watermark signal S_{WM}. It is assumed that a time length (e.g. 0.1, 0.5, or 1 second, and it is greater than a time delay n_{w}) of each of the digits is denoted by L_{b}. Similar to the concept of time-division multiplexing, the processor 59 divides a time period (i.e. a major time unit) of the sound watermark signal S_{WM} into minor time units with the same or different time lengths according to a digit number included in the watermark indication code Wₒ. Each of the minor time units carries the reflection sound signal with the phase shift corresponding to the different digit.

In an embodiment, if the filtering processing in FIG. 6 is adopted, the processor 59 may synthesize the one or multiple reflection sound signals with the phase shifts and the reflection sound signal s_{Rx}^{LP} undergoing the low-pass filtering processing. For example, in FIG. 8, the 90° phase shift φ (generating a reflection sound signal S₉₀ with the phase shift) is provided on the reflection sound signal S_{Rx}^{HP} undergoing the high-pass filtering processing, and a reflection sound signal S_{WO} with a phase shift is output. The processor 59 further synthesizes the reflection sound signal s_{Rx}^{LP} undergoing the low-pass filtering processing and the reflection sound signal S_{WO} with the phase shift to generate a sound watermark signal S_{WM1}.

In some embodiments, the processor 59 may generate multiple identical sound watermark signals. The sound watermark signals respectively correspond to different major time units. That is, the sound watermark signals are output in a loop. To distinguish the adjacent sound watermark signals, the processor 59 may add an interval between the adjacent sound watermark signals. For example, a mute signal or other known high-frequency sound signal is added at the interval.

In an embodiment, the processor 59 may respectively transmit the call reception sound signal S_{Rx} and the sound watermark signal S_{WM} through the communication transceiver 55. In another embodiment, the processor 59 may synthesize the call reception sound signal S_{Rx} and the sound watermark signal S_{WM} to generate an embedded watermark signal S_{Rx}+S_{WM}. Next, the processor 59 may transmit the embedded watermark signal S_{Rx}+S_{WM} through the communication transceiver 55.

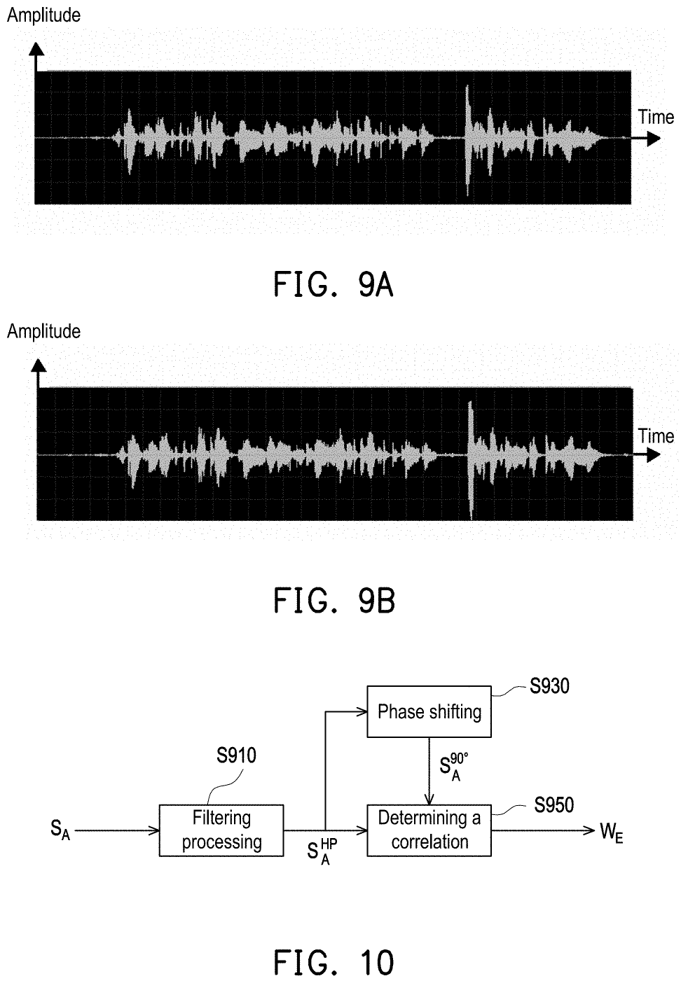

FIG. 9A is a simulation diagram describing the call reception sound signal S_{Rx} with an example. FIG. 9B is a simulation diagram describing the embedded watermark signal S_{Rx}+S_{WM} with an example. Referring to FIG. 9A and FIG. 9B, the two sounds are very similar, and it is difficult or impossible for a human to distinguish them.

The processor 19 of the conference terminal 10 receives the sound watermark signal S_{W}M or the embedded watermark signal S_{Rx}+S_{WM} through the communication transceiver 15 via the Internet to obtain a transmission sound signal S_{A} (i.e. the transmitted sound watermark signal S_{WM} or the embedded watermark signal S_{Rx}+S_{WM}). Since the sound watermark signal S_{WM} includes the call reception sound signal (i.e. the reflection sound signal) with the time delay and the amplitude attenuation, the echo cancellation of the processor 19 may effectively eliminate the sound watermark signal S_{WM}. Accordingly, a call transmission sound signal S_{Tx} (e.g. the call reception sound signal which the conference terminal 10 desires to transmit via the Internet) on the call transmission path may not be affected.

With regard to identifying the sound watermark signal S_{WM}, FIG. 10 is a flow chart describing watermark identification according to an embodiment of the disclosure. Referring to FIG. 10, in an embodiment, if the filtering processing in FIG. 6 is adopted, the processor 19 may perform the high-pass filtering processing on the transmission sound signal S_{A} by using the same or a similar high-pass filter HPF (step S910) to output a transmission sound signal S_{A}^{HP} undergoing the high-pass filtering processing. In another embodiment, if the filtering processing in FIG. 6 is not adopted, step S910 may be omitted (i.e. the transmission sound signal S_{A}^{HP} is the same as the transmission sound signal S_{A}).

The processor 19 may shift a phase of the transmission sound signal S_{A}^{HP} according to the correspondence relation between the value described in step S450 and the phase shift (i.e. in step S930, phase shifting is performed.). For example, in FIG. 8, the processor 19 generates a transmission sound signal S_{A}^{90°} with a 90° phase shift. The processor 19 may identify a watermark indication code W_{E} according to a correlation between the transmission sound signal S_{A}^{HP} and the transmission sound signal S_{A}^{90°} with the phase shift (step S950). For example, the processor 19 calculates an orthogonality correlation R_{xy}(n_{w}) and −1≤R_{xy}(n_{w})≤1 at the time delay area n_{w} of the transmission sound signal S_{A}^{HP} and the transmission sound signal S_{A}^{90°}. The processor 19 defines a threshold value Th_{R}, and the watermark indication code W_{E} may be represented as:

$${W}_{E} = \{ \begin{matrix}1 , {R}_{x y} ( {n}_{w} ) > T {h}_{R} \\ 0 , {R}_{x y} ( {n}_{w} ) < - T {h}_{R} \\ none , others\end{matrix} \qquad ( 5 )$$

That is, if the correlation is greater than the threshold value Th_{R}, the processor 19 determines that the value of the digit corresponds to a value (e.g. 1) of the 90° phase shift; if the correlation is less than the threshold value Th_{R}, the processor 19 determines that the value of the digit corresponds to a value (e.g. 0) of the −90° phase shift. In another embodiment, the processor 19 may transmit values of the transmission sound signal S_{A}^{HP} corresponding to different minor time units based on a deep learning classifier.

In summary of the above, in the processing method of the sound watermark and the sound watermark generating apparatus according to the embodiments of the disclosure, the reflection sound signal is simulated according to the principle of the echo cancellation, and the sound watermark signal is encoded by performing phase shifting on the reflection sound signal. Accordingly, at a receiving end, the sound watermark signal obtained through a feedback path may be eliminated by the echo cancellation, and the sound watermark signal does not affect the call transmission signal on the call transmission path.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A processing method of a sound watermark adapted for a conference terminal, wherein the conference terminal comprises a sound receiver, the processing method of the sound watermark comprises:
obtaining a call reception sound signal through the sound receiver;
generating a reflection sound signal according to a virtual reflection condition and the call reception sound signal, wherein the virtual reflection condition comprises a position relation among the sound receiver, a sound source, and an external object, and the reflection sound signal is a sound signal obtained by simulating a sound output by the sound source, then being reflected by the external object, and being further recorded by the sound receiver; and
shifting a phase of the reflection sound signal according to a watermark indication code to generate a sound watermark signal, wherein the sound watermark signal comprises the at least one reflection sound signal with a phase shift.

2. The processing method of the sound watermark according to claim 1, wherein generating the reflection sound signal according to the virtual reflection condition and the call reception sound signal comprises:
determining a time delay and an amplitude attenuation of the reflection sound signal compared with the call reception sound signal according to the position relation and a reflection coefficient of the external object.

3. The processing method of the sound watermark according to claim 1, wherein the watermark indication code is encoded with a multiple positional numeral system, a plurality of values are provided for each of at least one digit of the watermark indication code in the multiple positional numeral system, and shifting the phase of the reflection sound signal according to the watermark indication code comprises:
shifting the phase of the reflection sound signal according to the values of the at least one digit of the watermark indication code, wherein the different values correspond to a plurality of different phase shifts.

4. The processing method of the sound watermark according to claim 3, wherein the at least one digit of the watermark indication code comprises a plurality of digits, wherein the sound watermark signal comprises the plurality of the reflection sound signals with the phase shifts, and each of the reflection sound signals with the phase shifts occupies a time length in the sound watermark signal.

5. The processing method of the sound watermark according to claim 3, wherein the multiple positional numeral system is a binary numeral system, a first value and a second value are provided for each of at least one digit of the watermark indication code, and shifting the phase of the reflection sound signal comprises:
generating the reflection sound signal with a first phase shift in response to one of at least one digit of the watermark indication code being the first value; and
generating the reflection sound signal with a second phase shift in response to one of at least one digit of the watermark indication code being the second value.

6. The processing method of the sound watermark according to claim 1, wherein before shifting the phase of the reflection sound signal according to the watermark indication code, the processing method further comprises:
performing a low-pass filtering processing on the reflection sound signal; and
performing a high-pass filtering processing on the reflection sound signal, wherein only a phase of the reflection sound signal undergoing the high-pass filtering processing is shifted, and generating the sound watermark signal further comprises:
synthesizing the at least one reflection sound signal with the phase shift and the reflection sound signal undergoing the low-pass filtering processing.

7. The processing method of the sound watermark according to claim 1, further comprising:
receiving a transmission sound signal through an Internet, wherein the transmission sound signal comprises the transmitted sound watermark signal;
shifting a phase of the transmission sound signal; and
identifying the watermark indication code according to a correlation between the transmission sound signal and the transmission sound signal with the phase shift.

8. The processing method of the sound watermark according to claim 7, wherein before shifting the phase of the transmission sound signal, the processing method further comprises:
performing a high-pass filtering processing on the transmission sound signal, wherein only the phase of the transmission sound signal undergoing the high-pass filtering processing is shifted.

9. A sound watermark generating apparatus, comprising:
a memory configured to store a program code; and
a processor coupled to the memory and configured to load and execute the program code to:
obtain a call reception sound signal, wherein the call reception sound signal is obtained by recording through a sound receiver;
generate a reflection sound signal according to a virtual reflection condition and the call reception sound signal, wherein the virtual reflection condition comprises a position relation among the sound receiver, a sound source, and an external object, and the reflection sound signal is a sound signal obtained by simulating a sound output by the sound source, then being reflected by the external object, and being further recorded by the sound receiver; and
shift a phase of the reflection sound signal according to a watermark indication code to generate a sound watermark signal, wherein the sound watermark signal comprises the at least one reflection sound signal with a phase shift.

10. The sound watermark generating apparatus according to claim 9, wherein the processor is further configured to:
determine a time delay and an amplitude attenuation of the reflection sound signal compared with the call reception sound signal according to the position relation and a reflection coefficient of the external object.

11. The sound watermark generating apparatus according to claim 9, wherein the watermark indication code is encoded with a multiple positional numeral system, a plurality of values are provided for each of at least one digit of the watermark indication code in the multiple positional numeral system, and the processor is further configured to:
shift the phase of the reflection sound signal according to the values of the at least one digit of the watermark indication code, wherein the different values correspond to a plurality of different phase shifts.

12. The sound watermark generating apparatus according to claim 11, wherein the at least one digit of the watermark indication code comprises a plurality of digits, the sound watermark signal comprises the plurality of the reflection sound signals with the phase shifts, and each of the reflection sound signals with the phase shifts occupies a time length in the sound watermark signal.

13. The sound watermark generating apparatus according to claim 11, wherein the multiple positional numeral system is a binary numeral system, a first value and a second value are provided for each of at least one digit of the watermark indication code, and the processor is further configured to:
generate the reflection sound signal with a first phase shift in response to one of at least one digit of the watermark indication code being the first value; and
generate the reflection sound signal with a second phase shift in response to one of at least one digit of the watermark indication code being the second value.

14. The sound watermark generating apparatus according to claim 9, wherein the processor is further configured to:
perform a low-pass filtering processing on the reflection sound signal;
perform a high-pass filtering processing on the reflection sound signal, wherein only a phase of the reflection sound signal undergoing the high-pass filtering processing is shifted; and
synthesize the at least one reflection sound signal with the phase shift and the reflection sound signal undergoing the low-pass filtering processing.

15. The sound watermark generating apparatus according to claim 9, wherein the watermark indication code is identified according to a correlation between the transmitted sound watermark signal and the sound watermark signal with the phase shift.

16. The sound watermark generating apparatus according to claim 15, wherein the processor is further configured to:
perform a high-pass filtering processing on the transmission sound signal, wherein only the phase of the transmission sound signal undergoing the high-pass filtering processing is shifted.
